(19) United States
(12) Patent Application Publication
(10) Pub. No.: US 2010/0114972 A1
(43) Pub. Date: May 6, 2010

(54) ROOFTOP INDICATORS FOR ONLINE MAPS

(75) Inventor: Sean Michael Imler, Campbell, CA (US)

Correspondence Address: YAHOO C/O MOFO PALO ALTO, 755 PAGE MILL ROAD, PALO ALTO, CA, 94304, US

(73) Assignee: YAHOO! INC., Sunnyvale, CA (US)

(21) Appl. No.: 12/265,382

(22) Filed: Nov. 5, 2008

(51) Int. Cl. G06F 17/30; G06F 7/00

(52) U.S. Cl. 707/802; 707/E17.108; 707/E17.044

(57) ABSTRACT

A computer-readable medium encoded with executable instructions, by a processor, for associating information with map objects is provided. The instructions include instructions for receiving a request from a user for a map, and determining the map for the user in response to the request. The instructions further include instructions for determining a visual identifier associated with at least one map object included in the map for identifying the at least one map object. The visual identifier indicates available meta information associated with the at least one map object. The instructions include instructions for providing the map including the at least one map object identified by the visual identifier to the user.

### BACKGROUND OF THE INVENTION

Both offline and online mapping systems that provide users information about directions and locations are commonly utilized. With the Internet, the ease, accessibility, and detailed information of online maps have made these systems increasingly popular.

Presently, users have the option to view some maps in different realistic views, which may help a user identify a location. For example, a user may view a map by “streetview,” which comprise actual visuals captured along the street. A streetview may give users an idea of what the surrounding environment looks like from street level. In another example, a user may also view a map in a “satellite” view, which are comprised of overhead photographs from a satellite. However, the usefulness of these views is often limited to particular and limited zoom levels, which may not capture enough information to be useful to a user.

Currently, even with the level of detail, and different perspective views provided in these maps, users may still have difficulty recognizing a location. A user's familiarity with a geographical area is often limited to the geospatial context. For example, many users will recognize a location by landmarks or businesses in the area, but not know the street names in the location. When a user obtains driving directions, landmarks are a significant element in assisting the user in turn-by-turn directions.

Moreover, when a user requests a map of a business, often more information is desired about the business. A user may look up a store, but also is interested in the hours of the store, for example. A user may desire directions to a restaurant, but would also like to see other user reviews of the restaurant.

Therefore, methods and systems for providing maps indicating landmarks, while allowing a user to access more information about the landmark, is desired.

### BRIEF SUMMARY OF THE INVENTION

In accordance with embodiments of the present invention, a method for associating information with map objects is provided. The method includes receiving a request from a user for a map. In response to the request, a map is determined. The method further includes determining a visual identifier associated with at least one map object included in the map for identifying the at least one map object. The visual identifier indicates available meta information associated with the at least one map object. The method includes providing the map including the at least one map object identified by the visual identifier to the user.

Further, in accordance with embodiments of the present invention, a computer-readable medium encoded with executable instructions, by a processor, for associating information with map objects is provided. The instructions include instructions for receiving a request from a user for a map, and determining the map for the user in response to the request. The instructions further include instructions for determining a visual identifier associated with at least one map object included in the map for identifying the at least one map object. The visual identifier indicates available meta information associated with the at least one map object. The instructions include instructions for providing the map including the at least one map object identified by the visual identifier to the user.

Moreover, in accordance with embodiments of the present invention, a system for associating information with map objects is provided. The system includes logic for receiving a request from a user for a map. The system further includes a processor for determining the map for the user in response to the request, and for determining a visual identifier associated with at least one map object included in the map for identifying the at least one map object. The visual identifier indicates available meta information associated with the at least one map object. The system further includes a memory for storing the visual identifier, and logic for providing the map including the at least one map object identified by the visual identifier to the user.

Other features and aspects of the invention will become apparent from the following detailed description, taken in conjunction with the accompanying drawings which illustrate, by way of example, the features in accordance with embodiments of the invention. The summary is not intended to limit the scope of the invention.

### BRIEF DESCRIPTION OF THE DRAWINGS

FIG. 1 illustrates a general user interface including a map provided to a user after the user request the map;

FIG. 2 illustrates a flowchart of a method for associating information with a map object according to embodiments of the invention;

FIG. 3A illustrates a system for associating information with a map according to embodiments of the invention;

FIG. 3B illustrates a system for providing information associated with a rooftop image according to embodiments of the invention;

FIG. 4A illustrates a map of a region with indicators at a first zoom level according to embodiments of the invention;

FIG. 4B illustrates a map generated with satellite views of a region with indicators at the first zoom level according to embodiments of the invention;

FIG. 5 illustrates a flowchart of a method for authenticating a user authorized to add or edit indicators on a map according to embodiments of the invention;

FIG. 6A illustrates a map of a region with indicators at a second zoom level according to embodiments of the invention;

FIG. 6B illustrates a map generated with satellite views of a region with indicators at the second zoom level according to embodiments of the invention;

FIG. 7A illustrates a map of a region with indicators at a third zoom level according to embodiments of the invention;

FIG. 7B illustrates a map generated with satellite views of a region with indicators at the third zoom level according to embodiments of the invention;

FIG. 8A illustrates a map with indicators according to embodiments of the invention;

FIG. 8B illustrates a rollover action to select an indicator of a map according to embodiments of the invention;

FIG. 8C illustrates information associated with the selected indictor of FIG. 8B according to embodiments of the invention;

FIG. 9 illustrates information associated with a selected indicator according to embodiments of the invention; and

FIG. 10 illustrates a block diagram of a computing system according to embodiments of the invention.

In the following description, reference is made to the accompanying drawings which form a part thereof, and which illustrate several embodiments of the present invention. It is understood that other embodiments may be utilized and structural and operational changes may be made without departing from the scope of the present invention. The use of the same reference symbols in different drawings indicates similar or identical items.

### DETAILED DESCRIPTION OF THE INVENTION

The following description is presented to enable any person of ordinary skill in the art to make and use the invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown.

Typically, mapping systems require a user interface for a user to enter in a request for a map, and an interface where the map is provided for displaying to the requesting user.

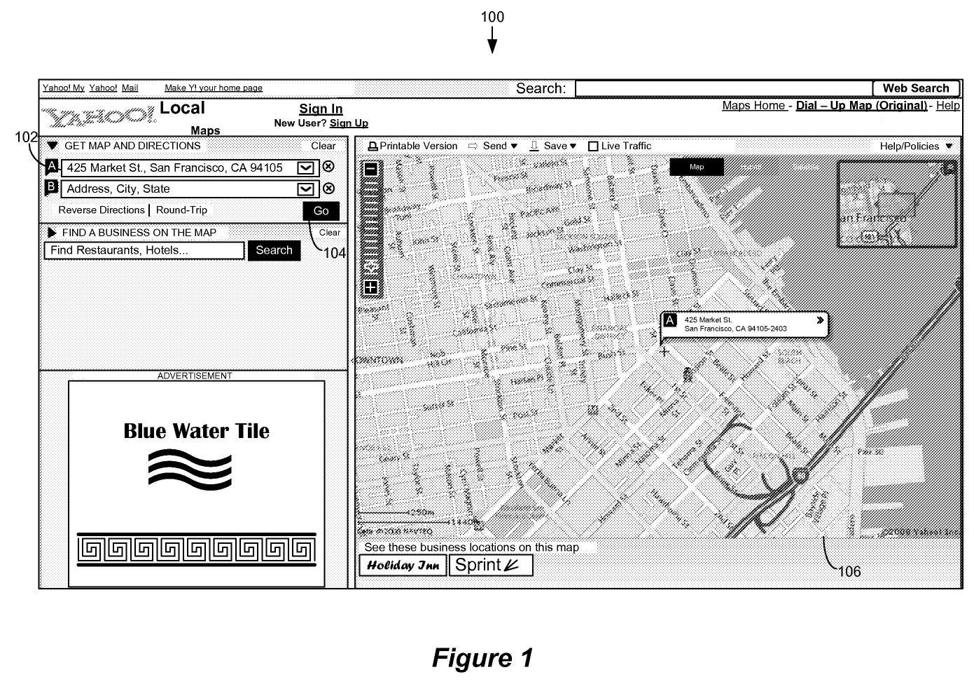

A general user interface 100 for a mapping website is illustrated in FIG. 1. The user may enter in the address of the desired location as a request in an entry box 100. As shown, a user has entered a desired location of 425 Market St., San Francisco, Calif. 94105. After entering the desired location to be mapped, as shown in FIG. 1, the user then requests a map (typically from a remote server) by selecting a button for submitting the request to a map server 104. A map image is then typically generated at the remote server, transmitted to the user's computing device, and eventually displayed on the web browser user interface in a map display web page 106.

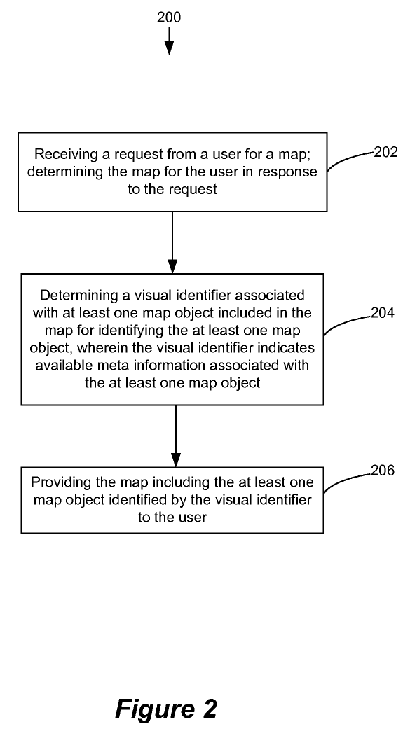

FIG. 2 illustrates a flowchart of a method for associating information with a map object according to embodiments of the invention.

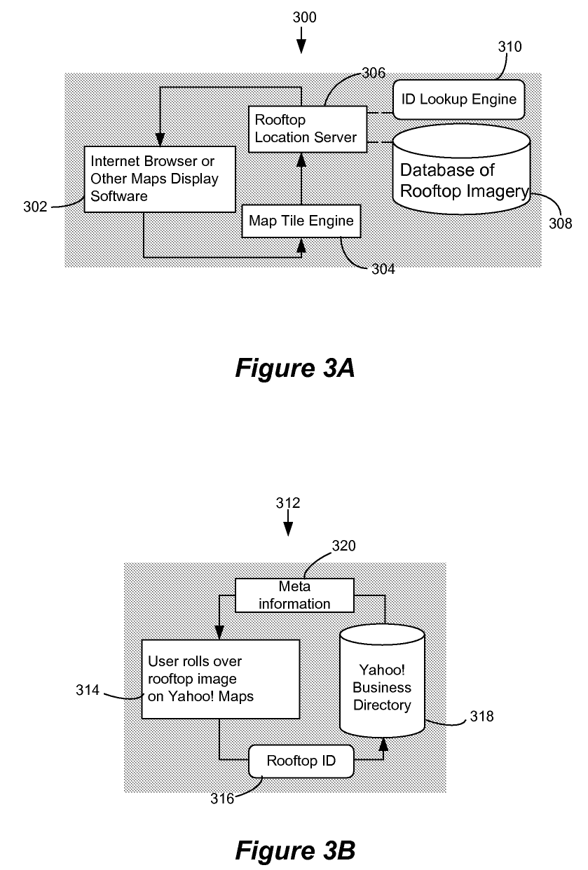

FIG. 3A illustrates a system for associating information with a map according to embodiments of the invention. In embodiments of the invention, the client 302 may constantly send latitude and longitude coordinates to a map tile engine 304, and a rooftop location server 306. The coordinates indicate the map that is displayed, or is desired to be displayed, by a client application at the client 302. The client application may be, but is not limited to, an internet browser or map display software. The map tile engine is generates the map indicated by the coordinates received from the client 302. The rooftop location server 306 uses the coordinates from the client 302 to query the rooftop imagery database 308 for rooftop imagery that has been stored corresponding to the coordinates. The rooftop location server 306 may also use the coordinates from the client to query the ID lookup engine 310 to determine any metadata that should be associated to the rooftop image.

FIG. 3B illustrates the in embodiments of the invention, the user rolls a cursor over a rooftop image on the map 314, and the coordinates, or other form of ID for the rooftop 316, is sent from the client to a database 318 where the meta information, or meta data associated with that particular rooftop, or business, is stored. The meta information 320 is then sent back to the client to display to the user along with the map.

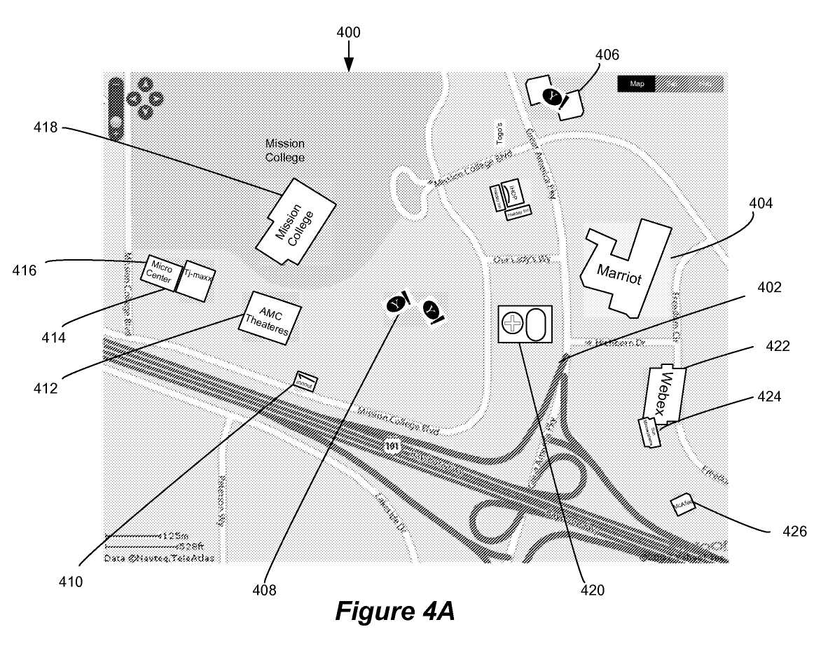

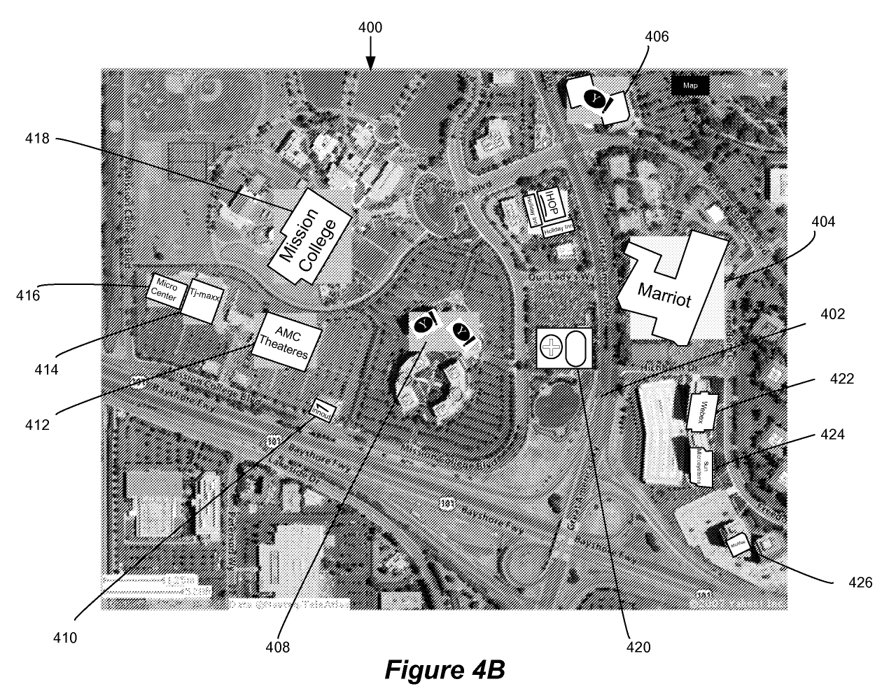

According to embodiments of the invention, FIG. 4A illustrates an example of a map 400 generated of a region with indicators at a first zoom level. In this map 400, as a typical map, roads and freeways have been rendered to provide user information about the region. The roads are labeled with the street names, such as road 402.

In addition, according to embodiments of the invention, the map further includes identifiers that illustrate the buildings and businesses included in the map 400. In this region included in map 400, there is an identifier 404 indicating the location of a Marriot hotel, an identifier 406 indicating the location of a Yahoo!, Inc. campus, an identifier 408 indicating the location of another Yahoo!, Inc. campus, an identifier 410 indicating an In-N-Out restaurant, and an identifier 412 indicating an AMC movie theater, for example. Several other identifiers, 414, 416, 418, 420, 422, 425, 426, and 430 indicate various companies, businesses, and landmarks shown in the map 400. An identifier may indicate, but is not limited to, companies, businesses, landmarks, and other places of information.

The identifier may include the business name. The identifier may include a business logo. An identifier is easily recognizable to a user, so that a user viewing the map may be able to recognize the region in the map by identifying businesses.

For example, the Yahoo!, Inc. business identifier 406 shows a recognizable “Y!” in the purple color associated with Yahoo!. A user familiar with the purple “Y!” logo would recognize that Yahoo!, Inc. was located where the identifier 406 was located on the map, even though the whole business name is not provided. As another example, the In-N-Out restaurant business identifier 410 is the name in red lettering with a yellow arrow, which is a logo recognizable by users. If there was an identifier provided on a map that showed golden arches, many people would easily recognize that the identifier indicated a location of a McDonalds restaurant.

By using business logos, the identifiers may be viewed from different zoom levels and still recognized by a user viewing the map.

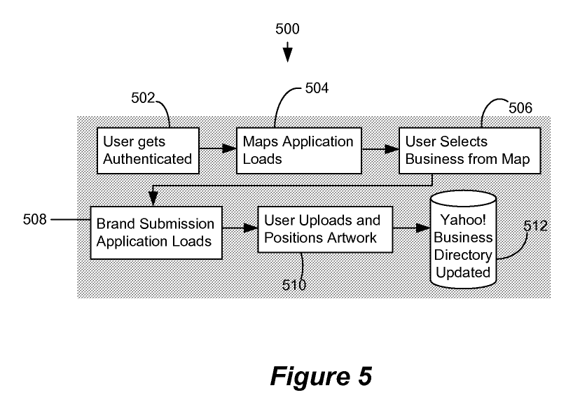

In some embodiments, a user should be authorized to add an identifier to a map. Therefore, the user should be authenticated before being allowed to add an identifier. A method for a user generating a rooftop image is illustrated in FIG. 5. In some embodiments, the user is authenticated based on the user's credentials, and/or affiliation with a particular business 502.

After it is determined the user has the authority to add information associated with a rooftop for a particular business, metadata or an image, for example, the user is provided with an editing user interface 504. This editing user interface would indicate to the authorized user the rooftops, or businesses, they may be allowed to edit. The editing user interface may indicate this to the user by drawing out the polygons represented the rooftops. The user may then verify that the polygon is indeed set over the rooftop of the respective rooftops representing their business or businesses. After a branding submission application loads 508, the user is able to select a particular rooftop and upload a branding image, for example, associated with the business corresponding to the selected rooftop 510. The branding image may be uploaded to the Yahoo! Business Directory database with the branding submission application 512. The branding submission application may also allow the user edit the image, by cutting and cropping, for example, in order to fit within the polygon designated for the rooftop.

For example, a user may be viewing map 400 because they needed directions to Sun Microsystems indicated by identifier 424. The driving directions the user obtains indicates he should travel south along the road Great America Parkway 402, turn left on Mission College Blvd. 432, and right on Freedom Circle 434. The user views the map 400 and notices, because of the identifier 406, that there is a Yahoo!, Inc. campus right before his planned left turn at Mission College Blvd. 432. Furthermore, the user notices that after turning right on Freedom Circle 434, there should be a Marriot hotel on his right, since there is an identifier 404 indicating the location. In this way, the user is able to recognize different business along his route to give him a better indication of his location and streets he is looking for.

An identifier identifies a location, but it also may indicate that there is information related to the business available to the user. Information related to the identifier may include the address of the business, a phone number, business hours, and user reviews of the business, for example.

Although there currently exists mapping systems that provide users with satellite views, and street views, which may provide additional contextual information to a user viewing the map, the perspective that satellite and street views provide may not assist the user to easily identify landmarks, such as businesses. A user may have trouble identifying landmarks in a map rendered with satellite images because the user may not be able to identify buildings from an overhead view, for example.

FIG. 4B illustrates the map 400 of FIG. 4A in a hybrid view of actual satellite images and rendered map objects at the first zoom level according to embodiments of the invention.

In this hybrid view, a mixed view of satellite images and generated map information, a user is provided a overhead view of actual satellite images with overlaid information, such as street names and freeway numbers. For example, the road 402 is labeled with its name, “Great America Pky.” This type of view may be helpful to a user because it illustrates actual images, but labels roads and freeways that may not be identifiable to a user from the perspective of the images.

As illustrated in FIG. 4B, the satellite views provided in map 400 provide more contextual information to the user, such as showing parking lots, green spaces, and building structures. Identifiers according to embodiments of the invention provide information identifying building structures, for example, viewable by the satellite images.

Because the identifiers do not necessarily have a lot of text since they may be business logos, the information does not clutter an already information-heavy map. Moreover, the identifiers are viewable at several zoom levels.

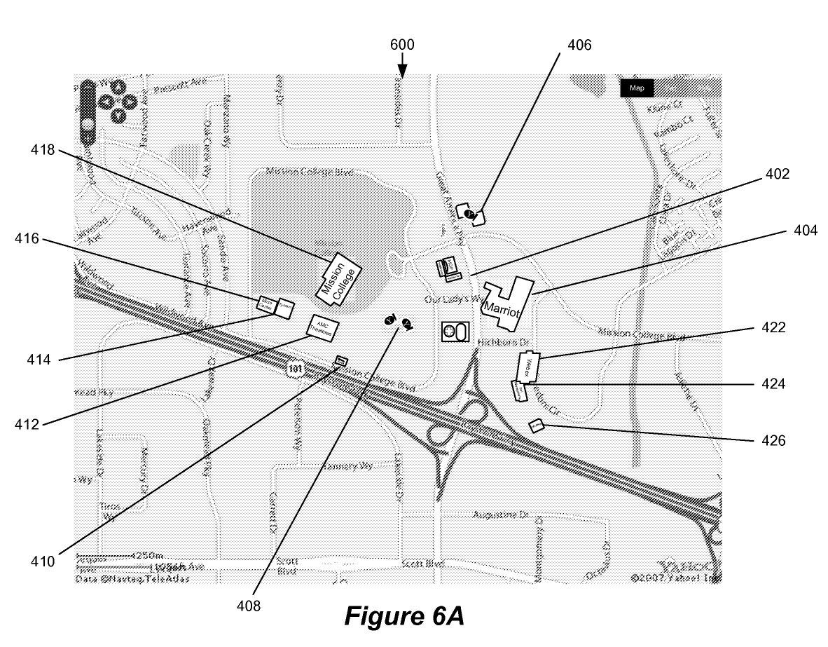

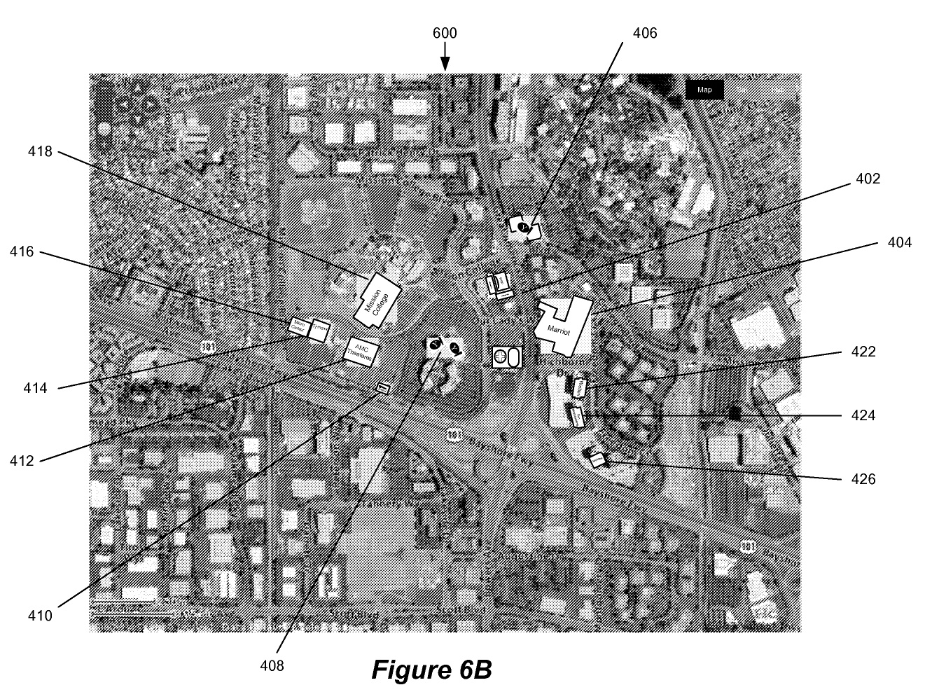

A second zoom level, a zoom out from the map 400 of FIG. 4A and FIG. 4B, or in other words, a zoom level that shows a larger region than shown in map 400, is illustrated in FIG. 5. FIG. 6A and 6B illustrates an example of a map 600 of a region with indicators at a second zoom level according to embodiments of the invention. At this zoom level, some text of the identifiers may be unreadable, but the logo may still be recognizable by users.

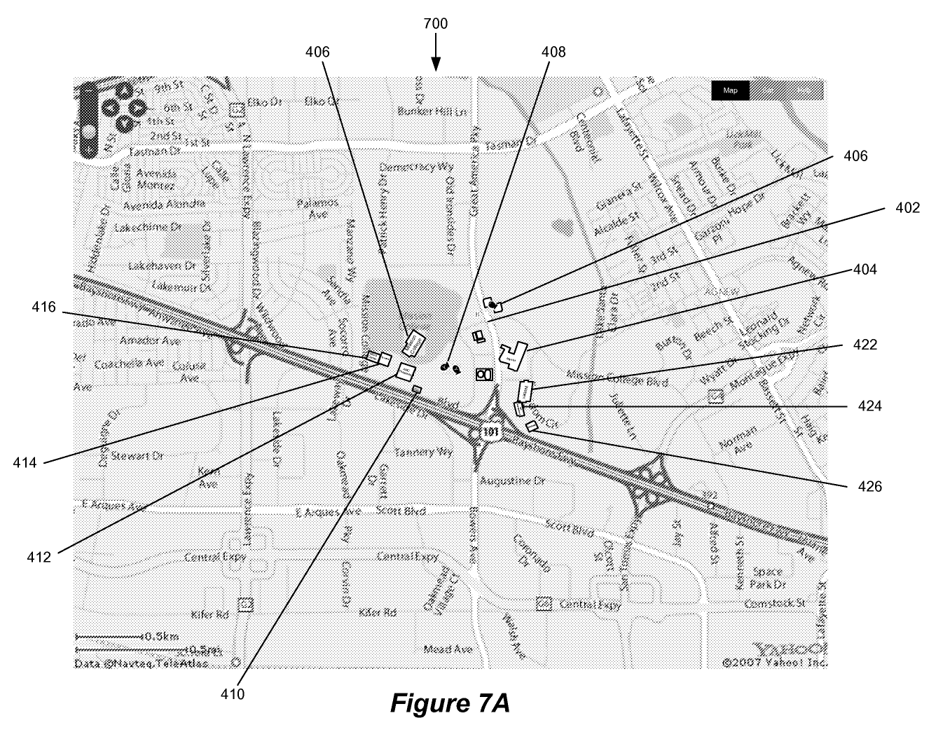

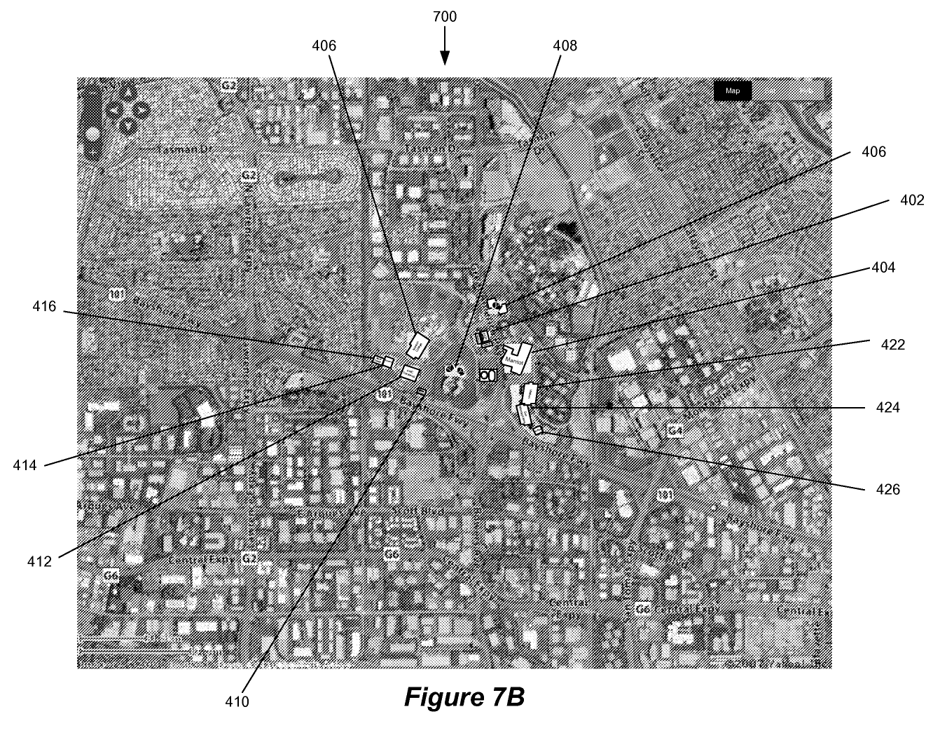

Similarly, a third zoom level, a zoom level that shows a larger region than shown in map 600, is illustrated in FIG. 7. FIG. 7 illustrates an example of a map of a region 700 with indicators at a third zoom level according to embodiments of the invention. At this zoom level, all text may be unreadable, but a logo may still be recognizable by users.

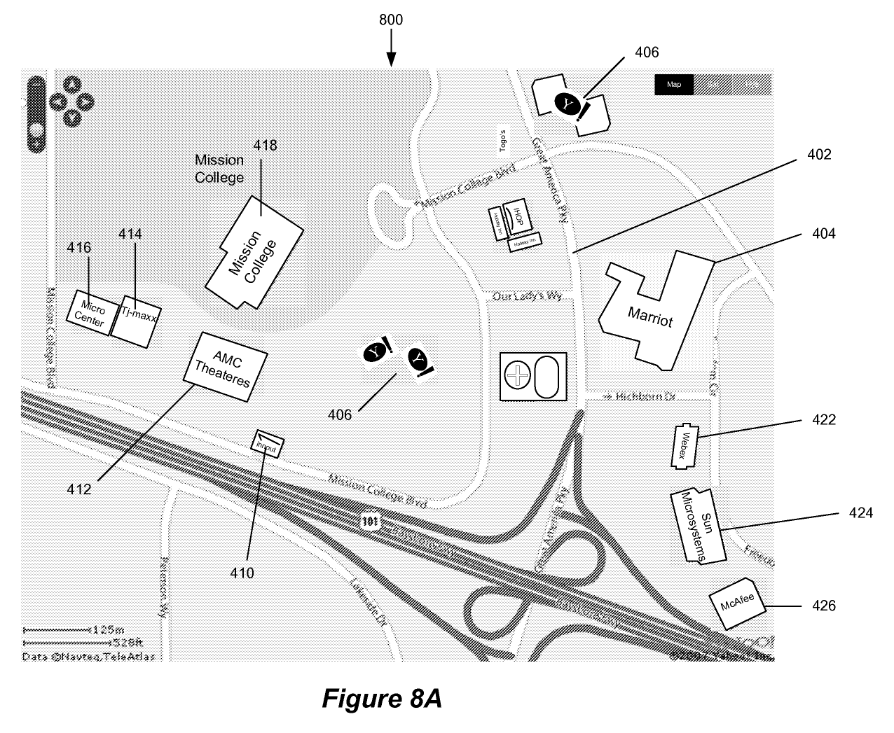

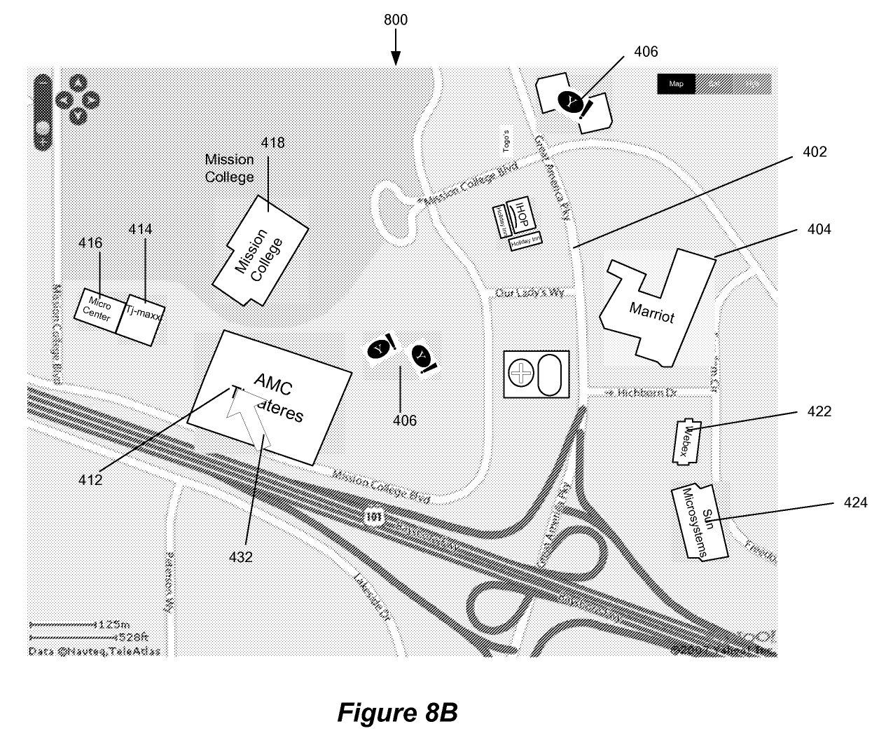

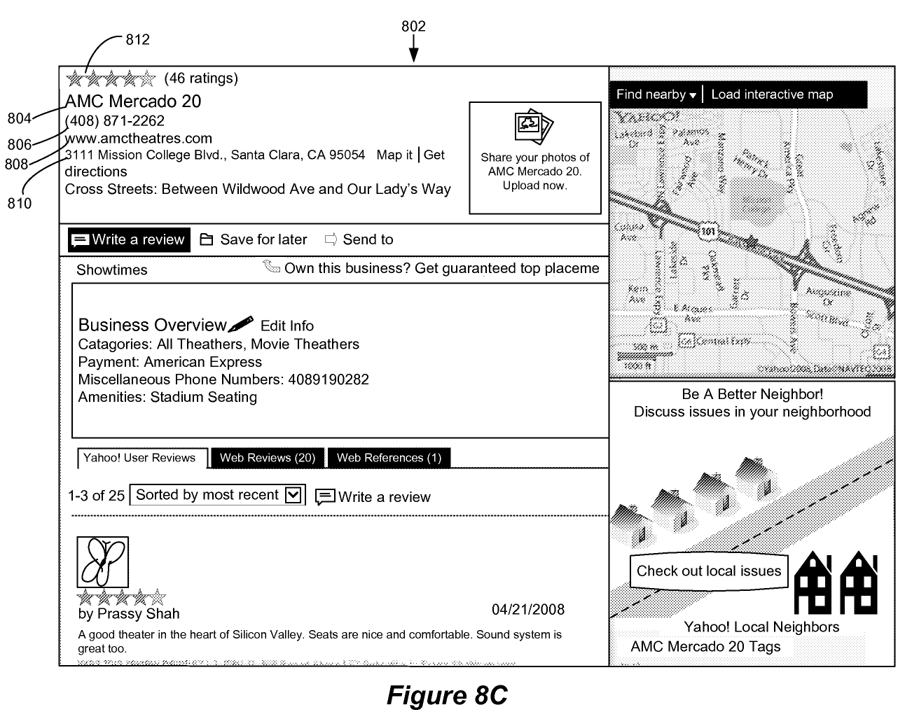

In addition to indicating a location of a business, an indicator may also indicate that there is information related to the business available to the user viewing the map. FIGS. 8A, 8B, and 8C illustrate an example how information associated with an identifier may be provided to the user according to embodiments of the invention.

FIG. 8A illustrates a map 800 including identifiers 404, 406, 406, 410, 412, 414, 416, 418, 420, 422, 424, and 426. A user viewing the map 800 sees that there is an AMC theater indicated by identifier 412. The user may then desire to see user ratings of that particular movie theater, or view upcoming movie showtimes.

The user may access this information by a user action on the identifier 412. FIG. 8B illustrates an example of a user action, such as a rollover event of a cursor on the identifier 412 to select an indicator of a map according to embodiments of the invention. An enlargement of the identifier 412, such as in FIG. 8B, may indicate to the user that information is available to the user related to the AMC theater.

The information related to the identifier 412 may be provided to the user in a plurality of ways. For example, the user may perform another user action on the identifier 412, such as a clicking action, thereby requesting the information associated with identifier 412.

Information related to identifier 412 may be the whole name of the business. In this case, “AMC Mercado 20” 804 is the full name of the business indicated by identifier 812. The phone number of the business 806, or street address 810 may also be provided. The official website of the business 808 may also be included in information provided to the user. Moreover, a user rating 812 may also be provided to the user.

The information related to an identifier is not limited to the examples illustrated, and may include any information related to a business. For example, information associated with a hotel identifier may include standard room rates, or information associated with a restaurant identifier may include business hours, user ratings, and a sample menu.

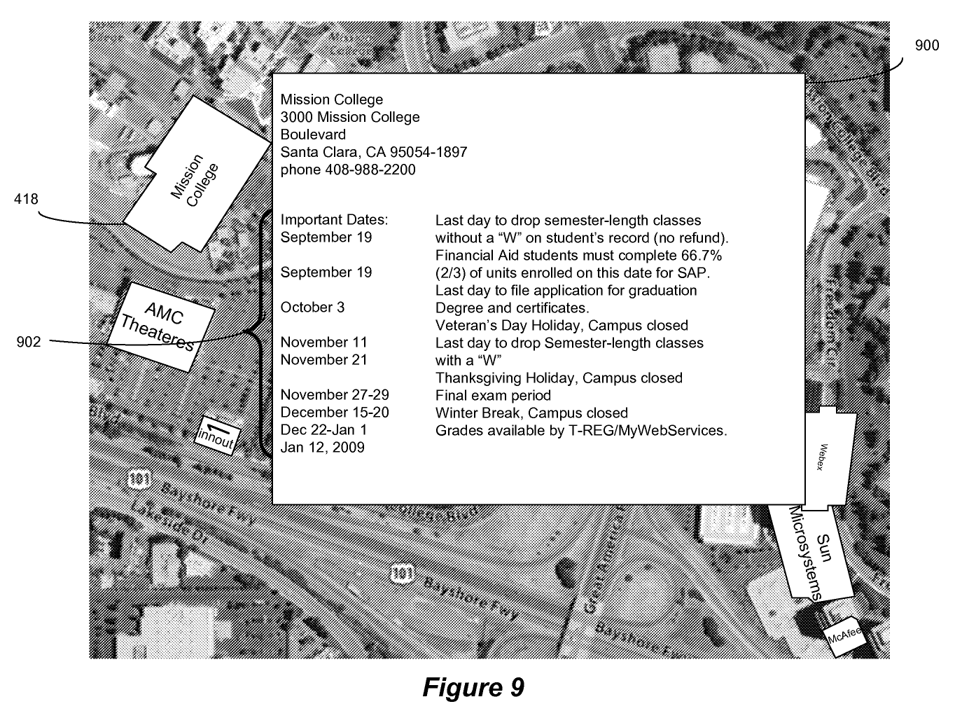

As illustrated in FIG. 8C, the information may be provided in a separate browser window to provide a separate website to the user, such as accessing a link. In other embodiments, the user may be provided the information in a window portion 900 provided along with the map as illustrated in FIG. 9.

FIG. 9 illustrates information that may be provided to the user after performing the user action on identifier 418. In this case, Mission College is used as an example and the associated information that is retrieved is a list of important dates 902 that Mission College has requested get delivered upon rollover. The business controls what data get presented. In this case, the business is Mission College.

Furthermore, the information related to an identifier may be static information, dynamically generated, an RSS feed, and information from other websites, for example.

While aspects of the invention, including the above described systems and methods, are described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic, and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

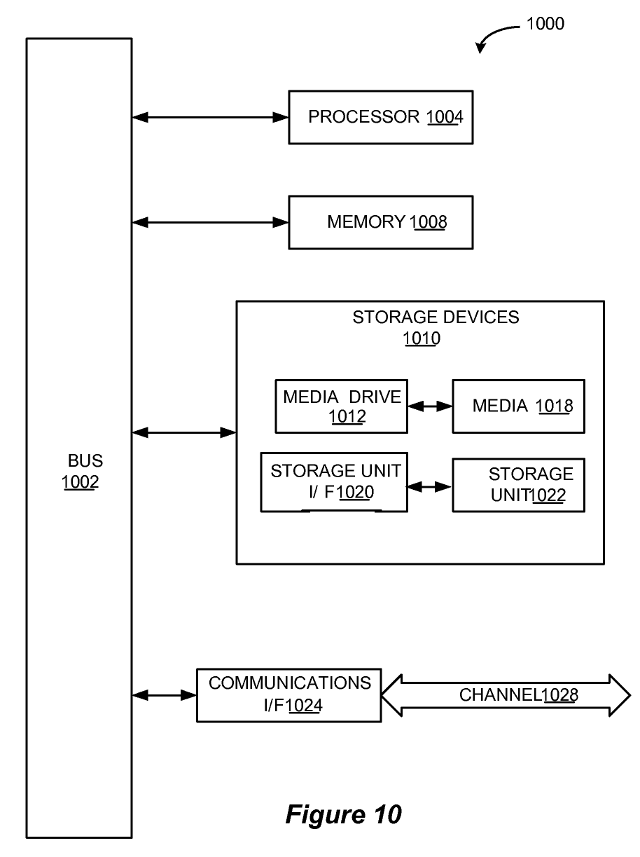

FIG. 10 illustrates an exemplary computing system 1000 that may be employed to implement processing functionality for various aspects of the invention (e.g., as a server device, client device, database, presence platform, combinations thereof, and so on). Those skilled in the relevant art will also recognize how to implement the invention using other computer systems or architectures. Computing system 1000 may represent, for example, a desktop, mainframe, server, client, or any other type of special or general purpose computing device as may be desirable or appropriate for a given application or environment. Computing system 1000 can include one or more processors, such as a processor 1004. Processor 1004 can be implemented using a general or special purpose processing engine such as, for example, a microprocessor, microcontroller or other control logic. In this example, processor 1004 is connected to a bus 1002 or other communication medium.

Computing system 1000 can also include a main memory 1008, for example random access memory (RAM) or other dynamic memory, for storing information and instructions to be executed by processor 1004. Main memory 1008 also may be used for storing temporary variables or other intermediate information during execution of instructions to be executed by processor 1004. Computing system 1000 may likewise include a read only memory (“ROM”) or other static storage device coupled to bus 1002 for storing static information and instructions for processor 1004.

The computing system 1000 may also include information storage mechanism 1010, which may include, for example, a media drive 1012 and a removable storage interface 1020. The media drive 1012 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 1018 may include, for example, a hard disk, floppy disk, magnetic tape, optical disk, CD or DVD, or other fixed or removable medium that is read by and written to by media drive 1014. As these examples illustrate, the storage media 1018 may include a computer-readable storage medium having stored therein particular computer software or data.

In alternative embodiments, information storage mechanism 1010 may include other similar instrumentalities for allowing computer programs or other instructions or data to be loaded into computing system 1000. Such instrumentalities may include, for example, a removable storage unit 1022 and an interface 1020, such as a program cartridge and cartridge interface, a removable memory (for example, a flash memory or other removable memory module) and memory slot, and other removable storage units 1022 and interfaces 1020 that allow software and data to be transferred from the removable storage unit 1018 to computing system 1000.

Computing system 1000 can also include a communications interface 1024. Communications interface 1024 can be used to allow software and data to be transferred between computing system 1000 and external devices. Examples of communications interface 1024 can include a modem, a network interface (such as an Ethernet or other NIC card), a communications port (such as for example, a USB port), a PCMCIA slot and card, etc. Software and data transferred via communications interface 1024 are in the form of signals which can be electronic, electromagnetic, optical, or other signals capable of being received by communications interface 1024. These signals are provided to communications interface 1024 via a channel 1028. This channel 1028 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 1008, storage device 1018, storage unit 1022, or signal(s) on channel 1028. These and other forms of computer-readable media may be involved in providing one or more sequences of one or more instructions to processor 1004 for execution. Such instructions, generally referred to as “computer program code” (which may be grouped in the form of computer programs or other groupings), when executed, enable the computing system 1000 to perform features or functions of embodiments of the present invention.

In an embodiment where the elements are implemented using software, the software may be stored in a computer-readable medium and loaded into computing system 1000 using, for example, removable storage drive 1014, drive 1012 or communications interface 1024. The control logic (in this example, software instructions or computer program code), when executed by the processor 1004, causes the processor 1004 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention. Moreover, aspects of the invention describe in connection with an embodiment may stand alone as an invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. A method for associating information with map objects, the method comprising:
receiving a request from a user for a map;
determining the map for the user in response to the request;
determining a visual identifier associated with at least one map object included in the map for identifying the at least one map object, wherein the visual identifier indicates available meta information associated with the at least one map object; and
providing the map including the at least one map object identified by the visual identifier to the user.

2. The method of claim 1, wherein the visual identifier is a logo.

3. The method of claim 1, wherein the visual identifier is associable with a business.

4. The method of claim 1, wherein the visual identifier is viewable in at least two zoom levels.

5. The method of claim 1, wherein the meta information associated with the at least one map object is viewable in a second area, wherein the map is viewable in a first area.

6. The method of claim 5, wherein the meta information associated with the at least one map object is viewable in the second area in response to a user action associated with the at least one map object.

7. The method of claim 1, wherein the meta information includes user-generated information.

8. The method of claim 1, wherein the meta information includes uploaded information.

9. The method of claim 1, wherein providing the map including the at least one map object identified by the visual identifier includes overlaying the visual identifier on the at least one map object.

10. The method of claim 9, wherein the visual identifier is overlaid such that the visual identifier is within boundaries of the at least one map object.

11. A computer-readable medium encoded with executable instructions, by a processor, for associating information with map objects, the instructions comprising instructions for:
receiving a request from a user for a map;
determining the map for the user in response to the request;
determining a visual identifier associated with at least one map object included in the map for identifying the at least one map object, wherein the visual identifier indicates available meta information associated with the at least one map object; and
providing the map including the at least one map object identified by the visual identifier to the user.

12. The computer-readable medium of claim 11, wherein the visual identifier is a logo.

13. The computer-readable medium of claim 11, wherein the visual identifier is associable with a business.

14. The computer-readable medium of claim 11, wherein the instructions further include instructions for providing the visual identifier so that the visual identifier is viewable in at least two zoom levels.

15. The computer-readable medium of claim 11, wherein the instructions further include instructions for providing the meta information associated with the at least one map object so that the meta information is viewable in a second area, wherein the map is viewable in a first area.

16. The computer-readable medium of claim 15, further comprising instructions for the meta information in the second area in response to a user action associated with the at least one map object.

17. The computer-readable medium of claim 11, wherein the meta information includes user-generated information.

18. The computer-readable medium of claim 11, wherein the meta information includes uploaded information.

19. The computer-readable medium of claim 11, wherein the instructions for providing the map including the at least one map object identified by the visual identifier are further for overlaying the visual identifier on the at least one map object.

20. The computer-readable medium of claim 19, wherein the visual identifier is overlaid such that the visual identifier is within boundaries of the at least one map object.

21. A system for associating information with map objects, the system comprising:
logic for receiving a request from a user for a map;
a processor for determining the map for the user in response to the request, and for determining a visual identifier associated with at least one map object included in the map for identifying the at least one map object, wherein the visual identifier indicates available meta information associated with the at least one map object;
a memory for storing the visual identifier; and
logic for providing the map including the at least one map object identified by the visual identifier to the user.

22. The system of claim 21, wherein the visual identifier is a logo.

23. The system of claim 21, wherein the visual identifier is associable with a business.

24. The system of claim 21, wherein the logic for providing the map is operable for providing the visual identifier such that the visual identifier is viewable in at least two zoom levels.

25. The system of claim 21, further comprising logic for providing the meta information associated with the at least one map object in a second area, wherein the map is viewable in a first area.

26. The system of claim 25, wherein the logic for providing the meta information associated with the at least one map object in a second area is further operable for providing the meta information in response to a user action associated with the at least one map object.

27. The system of claim 21, wherein the memory is further for storing the meta information.

28. The system of claim 21, wherein the logic for providing the map is operable for overlaying the visual identifier on the at least one map object, such that the visual identifier is within boundaries of the at least one map object.
